(19) United States
(12) Patent Application Publication
(10) Pub. No.: US 2002/0161619 A1
(43) Pub. Date: Oct. 31, 2002

(54) Method and system for arranging temporary project labor using the internet

(75) Inventors: Todd Ham, Alexandria, VA (US); Alan M. Foster, Rockledge, FL (US); Carl Grube, Indian Harbour Beach, FL (US)

Correspondence Address: CHRISTOPHER F. REGAN, Allen, Dyer, Doppelt, Milbrath & Gilchrist, P.A., P.O. Box 3791, Orlando, FL, 32802-3791, US

(73) Assignee: Harris Corporation, Melbourne, FL (US)

(21) Appl. No.: 09/845,826

(22) Filed: Apr. 30, 2001

(51) Int. Cl. G06F 17/60

(52) U.S. Cl. 705/9

(57) ABSTRACT

A method for arranging temporary project labor using the Internet includes posting a project description on the Internet, receiving a request via the Internet from a prospective laborer to be considered for the project, and making project training available to the prospective laborer, for example, via the Internet. Further, the prospective laborer may be required to demonstrate receipt of the project training via the Internet to be a contract laborer. Additionally, a project package may be transferred to the contract laborer via the Internet, a completed project package may be received from the contract laborer via the Internet, and an electronic payment may be authorized on behalf of the contract laborer via the Internet and based upon receiving the completed project package.

FIELD OF THE INVENTION

The present invention relates to the field of electronic commerce, and, more particularly, to a method and system for arranging temporary project labor using the Internet.

### BACKGROUND OF THE INVENTION

The growth of the Internet in recent years has resulted in a tremendous increase in the amount of information and services that Internet users may obtain from their own homes. For example, users may now comparison shop for and purchase electronics, vehicles, and a host of other products “on-line” without ever leaving their homes.

Another example where the Internet is providing greater convenience to users is in the area of employment. Because of the Internet, information may be instantaneously transferred between employer and employee regardless of their respective locations. As a result, stay-at-home mothers, people who live in remote locations, and those who simply desire extra work in their spare time are finding it much easier to obtain part-time or “freelance” employment over the Internet.

For example, Internet sites such as elance.com allow employers to post projects for which prospective laborers may bid. Prospective laborers may also post their resumes on the site for employers to search when they need a particular project completed. The prospective laborers may also pay an additional fee to the site provider to have certain of their credentials independently verified. The projects may include writing, translation, programming, tutoring, etc. Additionally, elance.com offers an optional billing and payment system to facilitate payment between employers and prospective laborers.

While Internet sites such as elance.com have made hiring temporary contract laborers easier, such sites are set up to match prospective laborers already having certain training with projects within their area of training. Yet, many employers may have projects that require specific training which only the employer can provide. Further, it may be desirable to make sure that the prospective laborers are willing and able to complete such training before expending the time and money necessary to contract with the prospective laborer.

### SUMMARY OF THE INVENTION

In view of the foregoing background, it is therefore an object of the invention to provide a method and system for arranging temporary project labor using the Internet that allows employers to make training available to project laborers prior to forming labor relations.

This and other objects, features, and advantages in accordance with the present invention are provided by a method for arranging temporary project labor using the Internet including posting a project description on the Internet, receiving a request via the Internet from a prospective laborer to be considered for the project, and making project training available to the prospective laborer, for example, via the Internet. The prospective laborer may be required to demonstrate receipt of the project training via the Internet to be a contract laborer. Additionally, a project package may be transferred to the contract laborer via the Internet, a completed project package may be received from the contract laborer via the Internet, and an electronic payment may be authorized on behalf of the contract laborer via the Internet and based upon receiving the completed project package.

More specifically, the prospective laborer may be required to take an examination to demonstrate mastery of the project training. The method may also include bypassing requiring of a prospective laborer to demonstrate receipt of the project training if the prospective laborer has previously been a contract laborer. Additionally, the method may include verifying that the completed project package complies with quality standards, and the electronic payment may be authorized after verifying that the completed project package complies with the quality standards. The request may be denied if a prior completed project package from the prospective laborer did not comply with the quality standards.

Furthermore, the project description may be re-posted on the Internet if the completed project package is not received from the contract laborer within a predetermined period. The project description may include laborer qualifications, and the method may further include verifying that the prospective laborer meets the laborer qualifications to be a contract laborer. The laborer qualifications may include at least one of a minimum age, citizenship, lack of a criminal record, having a valid taxpayer identification number, and having a valid social security number, for example. Further, the project may include at least one of writing, editing, translating, drafting, data entry, image recognition, image manipulation, and image accuracy transference.

A system for arranging temporary project labor using the Internet according to the invention includes a host system connected to the Internet having a project description, project training, and a project package stored therein. The host system may receive a request via the Internet from a prospective laborer to be considered for the project, make the project training available to the prospective laborer, and require the prospective laborer to demonstrate receipt of the project training via the Internet to be a contract laborer. Further, the host system may transmit the project package to the contract laborer via the Internet and receive a completed project package from the contract laborer via the Internet.

More specifically, the host system may make the project training available via the Internet and require the prospective laborer to take an examination to demonstrate mastery of the project training. The host system may also bypass requiring a prospective laborer to demonstrate receipt of the project training if the prospective laborer has previously been a contract laborer.

Additionally, the host system may store quality standards and verify that the completed project package complies with the quality standards. The host system may deny the request if a prior completed project package from the prospective laborer did not comply with the quality standards. The host system may also re-post the project description on the Internet if the completed project package is not received from the contract laborer within a predetermined period.

Furthermore, the host system may authorize an electronic payment on behalf of the contract laborer via the Internet and based upon receiving the completed project package. The electronic payment may be authorized after the host system verifies that the completed project package complies with the quality standards, for example.

The project description may also include laborer qualifications, and the host system may verify that the prospective laborer meets the laborer qualifications to be a contract laborer. The laborer qualifications may include at least one of a minimum age, citizenship, lack of a criminal record, having a valid taxpayer identification number, and having a valid social security number. Further, the project may include at least one of writing, editing, translating, drafting, data entry, image recognition, image manipulation, and image accuracy transference.

### BRIEF DESCRIPTION OF THE DRAWINGS

FIG. 1 is a schematic block diagram of a system for arranging temporary project labor using the Internet according to the invention.

FIG. 2 is a flow diagram illustrating a method according to the invention for arranging temporary project labor using the Internet.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

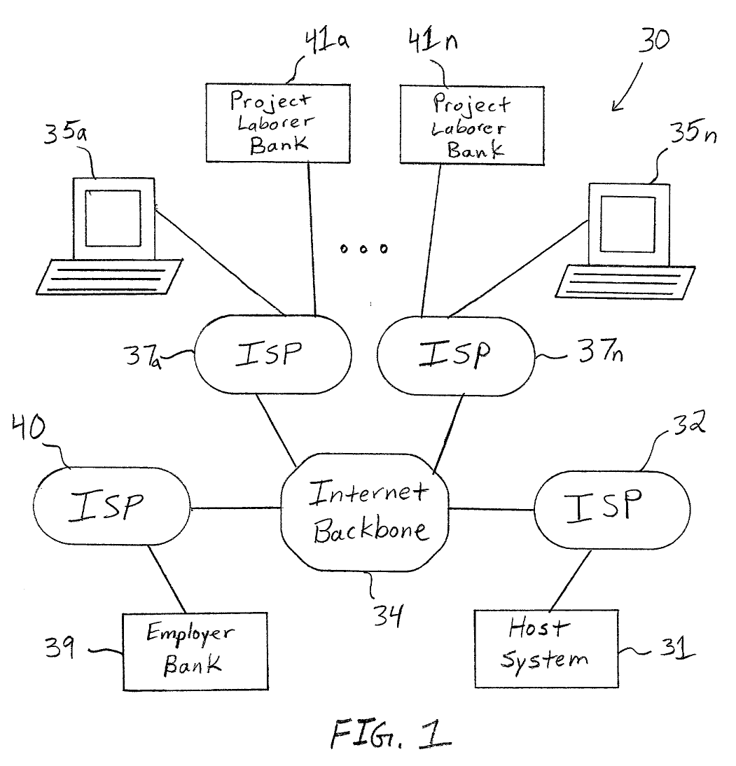

Referring to FIG. 1, the general architecture of a system 30 for arranging temporary project labor using the Internet is now described. The system 30 includes an employer's host system 31 connected via an Internet service provider (ISP) 32 (e.g., AT&T or UUNET) to an Internet backbone 34. The Internet backbone 34 is made up of multiple computer networks interconnected with high speed data lines for transmitting and receiving data, as will be readily appreciated by those skilled in the art.

Computers 35a-35n may also be connected to the Internet backbone 34 via ISPs 37a-37n. The computers 35a-35n may be individual home computers, for example, that may be located anywhere throughout the world where Internet access is available. The computers 35 allow prospective laborers to access the host system 31 and view projects that the employer needs completed, as will be described further below. Furthermore, a bank 39 used by the employer may also be connected to the Internet backbone 34 via an ISP 40 which allows the employer to electronically authorize payment to be deposited in banks 41a-41n used by contract laborers upon completion of projects, as will also be described further below. It should be noted that while multiple ISPs have been illustrated in FIG. 1, multiple computers or computer systems may share a common ISP or may themselves be an ISP, as will be appreciated by those of skill in the art.

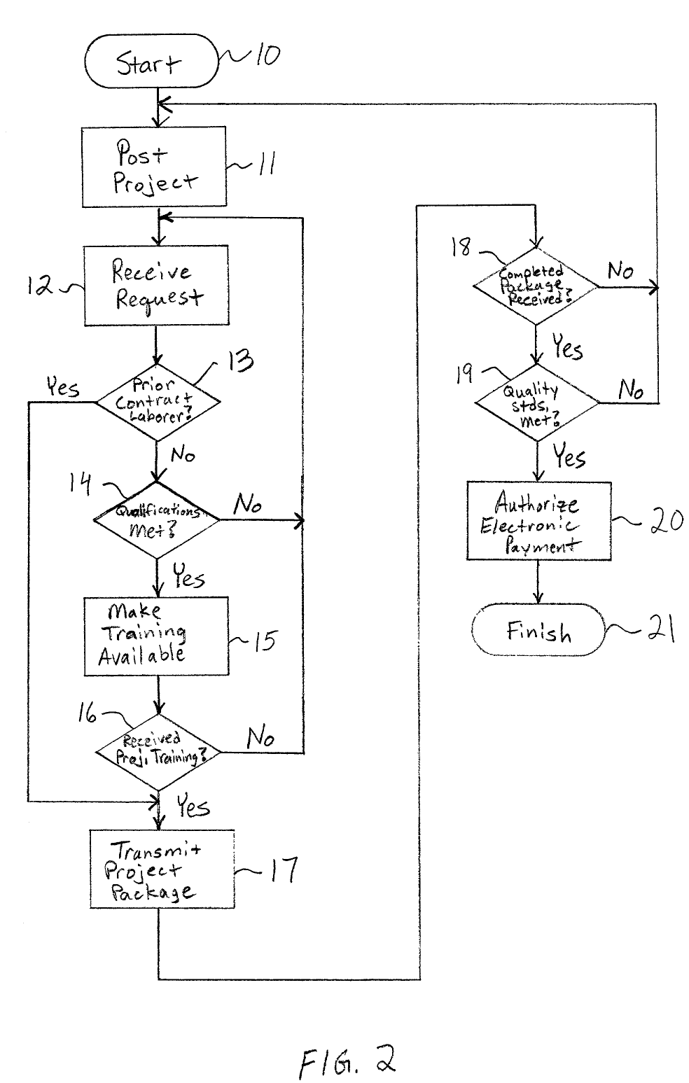

A method according to the invention for arranging temporary project labor using the system 30 will be described with reference to the flow diagram of FIG. 2. The method begins (Block 10) by posting a project description on the Internet, at Block 11. For example, the project description may be posted on the employer's web site maintained on the host system 31. The present invention is particularly well suited for discrete projects for which the employer only requires temporary laborers, such as writing, editing, translating, drafting, data entry, image recognition, image manipulation, and image accuracy transference. Of course, those of skill in the art will appreciate that this list is in no way exhaustive and that many other types of projects may be included within the scope of the present invention.

By way of example, the Harris Corporation, assignee of the present invention, provides a geographical modeling service RealSite™ which produces geospatially accurate, three-dimensional (3D) urban models. Multiple images of a city or other geographical location are acquired and a 3D model may be rendered from these images. The models may be used for applications such as urban planning or even planning military missions, for example. Yet, before computer software may be used to render the 3D images, human operators typically must physically delineate boundaries within the images (i.e., perform image recognition), such as rooftops of buildings. This process can be very labor intensive and, for large geographical areas, may require a long time to complete if only a few operators are available. Another similar application may be using registered imagery to bring inaccurate line maps into proper absolute positioning within a global datum (i.e., image accuracy transference), as will be understood by those of skill in the art.

The present invention provides for quick and economical scaling of labor to meet the demands of such labor intensive projects. While the above described image recognition is not particularly difficult, it does require that the operator receive specific training for using the delineation software. Accordingly, it would not be possible using existing freelance Internet sites to ensure that a prospective laborer has received the requisite project training before offering the prospective laborer the project.

According to the present invention, a prospective laborer logs on to the employer's Internet site via the Internet using the computer 35a to view the project description. Of course, multiple project descriptions spanning single or multiple disciplines may be listed on the employer's Internet site in accordance with the present invention, although a single project is referenced herein for clarity of understanding. The prospective laborer may then send a request via the Internet to be considered for the project (Block 12) which is received by the host system 31. The host system 31 may then determine if the prospective laborer has previously been a contract laborer for the employer on similar projects based upon information in a database in the host system of prior contract laborers, for example, at Block 13. If so, the prospective laborer has previously demonstrated that he meets predetermined qualifications and that he has previously received project training (discussed further below). Accordingly, the steps illustrated at Blocks 14-16 may be bypassed.

Otherwise, the host system 31 may verify that the prospective laborer meets laborer qualifications set forth in the project-description to be a contract laborer (Block 14). For example, the laborer qualifications may include a minimum age, citizenship, lack of a criminal record, having a valid taxpayer identification number, having a valid social security number, and not being a current employee of the employer. The prospective laborer is preferably prompted to input information relating to such qualifications upon requesting the project. If the host system 31 determines that these qualifications are not met, the host system 31 may deny the request and a next request from another prospective laborer may be received and processed.

If the qualifications have been met, project training stored on the host system 31 may then be made available to the prospective laborer, at Block 15. For example, the project training may be made available via the Internet and may include text documents, interactive demonstrations, etc. that the prospective laborer downloads and views on the computer 35. The prospective laborer may then be required by the host system 31 to demonstrate that he has received the project training via the Internet. For example, the prospective laborer may be required to take an examination to demonstrate mastery of the project training. The examination is preferably automated and taken over the Internet to minimize the time required by the employer in verifying training.

Using the above example, a prospective laborer may be required to view a short demonstration on how to delineate boundaries and then given an actual image with boundaries to delineate. The host system 31 may then “grade” the examination to see if the boundaries have been correctly delineated. If not, the request may be denied and a next request from another prospective laborer may be received. Other alternatives may include requiring the prospective laborer to view a sequence of training slides and, upon completion, providing the prospective laborer a code to demonstrate that the training has been received. Of course, other alternatives for verifying training may also be used within the scope of the present invention, as will be appreciated by those of skill in the art.

If the prospective laborer has received the training, the prospective laborer may then become a contract laborer, and a project package stored on the host system 31 may be transmitted to the contract laborer via the Internet (Block 17). The job description is then preferably removed from the employer's Internet site by the host system 31 for a predetermined period sufficient to allow the contract laborer to complete the project. If a completed project package is not received from the contract laborer via the Internet at the host system 31 within the predetermined period (Block 18), the project description may be re-posted on the employer's Internet site by the host system 31 for other prospective laborers to view.

The method may further include verifying that the completed project package complies with quality standards corresponding to the project, at Block 19. The quality control standards may either be checked manually or, in certain applications, may be checked by the host system 31. Using the above example, when an image delineation project is posted on the employer's Internet site, the employee posting the project may note that a certain number of objects require delineation in the project. The software which then renders the models from the completed project package may verify that the correct number of objects have actually been delineated. If not, the project package may be transmitted to the contract laborer for correction, or the project may be re-posted on the Internet by the host system 31 for another prospective laborer.

Another advantageous feature of the invention is that if a completed project package does not comply with the quality standards, this fact may be retained in a performance history of the contract laborer stored on the host system 31 so that his future requests for related projects may be denied, for example. On the other hand, continued compliance with the quality standards on repeated projects may entitle the contract laborer to bonuses, additional projects, etc.

Once it has been verified that the quality standards have been met, the host system 31 may authorize an electronic payment from the bank 39 to the bank 41 on behalf of the contract laborer (Block 20), thus completing the method, at Block 21. For example, this payment may be made electronically using Internet banks or wire transfers, for example, although traditional payment methods (e.g., checks) may also be used. Of course, taxpayer reporting information for the contract laborer may be stored in the host system 31 upon payment for later use in generating income statements for tax purposes, for example.

It will be appreciated by those of skill in the art that the system and method of the present invention therefore allow very rapid scaling for labor intensive projects that require a quick turn-around. Again using the above application, if a customer requests a geographical site model covering 1400 square kilometers within two weeks, and each square kilometer requires an average of seven man hours of image delineation, it would take 123 full time employees to complete the task in such time, assuming they started immediately and worked 40 hours per week. However, it may not be practicable to staff this many full-time employees for a single task, particularly when these employees must be paid benefits and certain minimum company salaries. In fact, it is preferable that the contract laborers not be made full-time or salaried employees of the employer for such reasons, although the contract laborers may be made employees according to the invention, if desired. The difficulties of maintaining such a staff become particularly acute when the volume of orders that the employer processes are highly variable.

By using the system and method of the present invention, prospective laborers from around the world will have access to the project descriptions and can complete the projects at home. This provides a labor pool of potentially millions of prospective laborers, or more, which may be particularly advantageous when a surge of laborers is required. Further, the projects may be discrete so that stay-at-home mothers, college or high school students, people with disabilities, or others with intermittent periods of free time available may earn extra money when they choose. Also, Email addresses of contract laborers with favorable performance histories may be stored and notices of new projects may be sent to such contract laborers when they become available.

Of course, many other modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. A method for arranging temporary project labor using the Internet and comprising:
posting a project description on the Internet;
receiving a request via the Internet from a prospective laborer to be considered for the project;
making project training available to the prospective laborer;
requiring the prospective laborer to demonstrate receipt of the project training via the Internet to be a contract laborer;
transmitting a project package to the contract laborer via the Internet; and
receiving a completed project package from the contract laborer via the Internet.

2. The method according to claim 1 wherein making project training available comprises making project training available via the Internet.

3. The method according to claim 1 wherein requiring the prospective laborer comprises requiring the prospective laborer to take an examination to demonstrate mastery of the project training.

4. The method according to claim 1 further comprising bypassing requiring of a prospective laborer to demonstration mastery of the project training if the prospective laborer has previously been a contract laborer.

5. The method according to claim 1 further comprising verifying that the completed project package complies with quality standards.

6. The method according to claim 5 further comprising denying a received request from a prospective laborer if a prior completed project package from the prospective laborer did not comply with the quality standards.

7. The method according to claim 1 further comprising re-posting the project description on the Internet if the completed project package is not received from the contract laborer within a predetermined period.

8. The method according to claim 1 wherein the project description comprises laborer qualifications; and further comprising verifying that the prospective laborer meets the laborer qualifications to be a contract laborer.

9. The method according to claim 8 wherein the laborer qualifications comprise at least one of a minimum age, citizenship, lack of a criminal record, having a valid taxpayer identification number, and having a valid social security number.

10. The method according to claim 1 wherein the project comprises at least one of writing, editing, translating, drafting, data entry, and image recognition.

11. A method for arranging temporary project labor using the Internet and comprising:
posting a project description on the Internet;
receiving a request via the Internet from a prospective laborer to be considered for the project;
making project training available to the prospective laborer;
requiring the prospective laborer to demonstrate receipt of the project training via the Internet to be a contract laborer;
transmitting a project package to the contract laborer via the Internet;
receiving a completed project package from the contract laborer via the Internet; and
authorizing an electronic payment on behalf of the contract laborer via the Internet based upon receiving the completed project package.

12. The method according to claim 11 wherein making project training available comprises making project training available via the Internet.

13. The method according to claim 11 wherein requiring the prospective laborer comprises requiring the prospective laborer to take an examination to demonstrate mastery of the project training.

14. The method according to claim 11 further comprising bypassing requiring of a prospective laborer to demonstrate receipt of the project training if the prospective laborer has previously been a contract laborer.

15. The method according to claim 11 further comprising verifying that the completed project package complies with quality standards.

16. The method according to claim 15 wherein authorizing comprises authorizing the electronic payment after verifying that the completed project package complies with the quality standards.

17. The method according to claim 15 further comprising denying a received request from a prospective laborer if a prior completed project package from the prospective laborer did not comply with the quality standards.

18. The method according to claim 11 further comprising re-posting the project description on the Internet if the completed project package is not received from the contract laborer within a predetermined period.

19. The method according to claim 11 wherein the project description comprises laborer qualifications; and further comprising verifying that the prospective laborer meets the laborer qualifications to be a contract laborer.

20. The method according to claim 19 wherein the laborer qualifications comprise at least one of a minimum age, citizenship, lack of a criminal record, having a valid taxpayer identification number, and having a valid social security number.

21. The method according to claim 11 wherein the project comprises at least one of writing, editing, translating, drafting, data entry, image recognition, image manipulation, and image accuracy transference.

22. A method for arranging temporary project labor using the Internet and comprising:
posting a project description on the Internet, the project having quality standards associated therewith;
receiving a request via the Internet from a prospective laborer to be considered for the project;
making project training available to the prospective laborer via the Internet;
transmitting a project package to the contract laborer via the Internet;
receiving a completed project package from the contract laborer via the Internet; and
authorizing an electronic payment on behalf of the contract laborer via the Internet based upon receiving the completed project package and verifying that the completed project package complies with the quality standards.

23. The method according to claim 22 further comprising denying a received request from a prospective laborer if a prior completed project package from the prospective laborer did not comply with the quality standards.

24. The method according to claim 22 further comprising re-posting the project description on the Internet if the completed project package is not received from the contract laborer within a predetermined period.

25. The method according to claim 22 wherein the project description comprises laborer qualifications; and further comprising verifying that the prospective laborer meets the laborer qualifications to be a contract laborer.

26. The method according to claim 25 wherein the laborer qualifications comprise at least one of a minimum age, citizenship, lack of a criminal record, having a valid taxpayer identification number, and having a valid social security number.

27. The method according to claim 22 wherein the project comprises at least one of writing, editing, translating, drafting, data entry, image recognition, image manipulation, and image accuracy transference.

28. A system for arranging temporary project labor using the Internet and comprising:
a host system connected to the Internet and storing a project description, project training, and a project package therein, said host system
receiving a request via the Internet from a prospective laborer to be considered for the project,
making the project training available to the prospective laborer,
requiring the prospective laborer to demonstrate receipt of the project training via the Internet to be a contract laborer,
transmitting the project package to the contract laborer via the Internet, and
receiving a completed project package from the contract laborer via the Internet.

29. The system according to claim 28 wherein said host system makes the project training available via the Internet.

30. The system according to claim 28 wherein said host system requires the prospective laborer to take an examination to demonstrate mastery of the project training.

31. The system according to claim 28 wherein said host system bypasses requiring a prospective laborer to demonstrate receipt of the project training if the prospective laborer has previously been a contract laborer.

32. The system according to claim 28 wherein said host system stores quality standards; and wherein said host system verifies that the completed project package complies with the quality standards.

33. The system according to claim 32 wherein said host system denies a received request from a prospective laborer if a prior completed project package from the prospective laborer did not comply with the quality standards.

34. The system according to claim 28 wherein said host system re-posts the project description on the Internet if the completed project package is not received from the contract laborer within a predetermined period.

35. The system according to claim 28 wherein the project description comprises laborer qualifications; and wherein said host system verifies that the prospective laborer meets the laborer qualifications to be a contract laborer.

36. The system according to claim 35 wherein the laborer qualifications comprise at least one of a minimum age, citizenship, lack of a criminal record, having a valid taxpayer identification number, and having a valid social security number.

37. The system according to claim 28 wherein the project comprises at least one of writing, editing, translating, drafting, data entry, image recognition, image manipulation, and image accuracy transference.

38. A system for arranging temporary project labor using the Internet and comprising:
a host system connected to the Internet and storing a project description, project training, and a project package therein, said host system
receiving a request via the Internet from a prospective laborer to be considered for the project,
making the project training available to the prospective laborer,
requiring the prospective laborer to demonstrate receipt of the project training via the Internet to be a contract laborer,
transmitting the project package to the contract laborer via the Internet,
receiving a completed project package from the contract laborer via the Internet, and
authorizing an electronic payment on behalf of the contract laborer via the Internet and based upon receiving the completed project package.

39. The system according to claim 38 wherein said host system makes the project training available via the Internet.

40. The system according to claim 38 wherein said host system requires the prospective laborer to take an examination to demonstrate mastery of the project training.

41. The system according to claim 38 wherein said host system bypasses requiring a prospective laborer to demonstrate receipt of the project training if the prospective laborer has previously been a contract laborer.

42. The system according to claim 38 wherein said host system stores quality standards; and wherein said host system verifies that the completed project package complies with the quality standards.

43. The system according to claim 42 wherein said host system denies a received request from a prospective laborer if a prior completed project package from the prospective laborer did not comply with the quality standards.

44. The system according to claim 42 wherein said host system authorizes the electronic payment after verifying that the completed project package complies with the quality standards.

45. The system according to claim 38 wherein said host system re-posts the project description on the Internet if the completed project package is not received from the contract laborer within a predetermined period.

46. The system according to claim 38 wherein the project description comprises laborer qualifications; and wherein said host system verifies that the prospective laborer meets the laborer qualifications to be a contract laborer.

47. The system according to claim 46 wherein the laborer qualifications comprise at least one of a minimum age, citizenship, lack of a criminal record, having a valid taxpayer identification number, and having a valid social security number.

48. The system according to claim 38 wherein the project comprises at least one of writing, editing, translating, drafting, data entry, image recognition, image manipulation, and image accuracy transference.
